(19) United States
(12) Patent Application Publication
(10) Pub. No.: US 2006/0191369 A1
(43) Pub. Date: Aug. 31, 2006

(54) Electromechanical cable actuator assembly

(76) Inventors: Ray Cockerham, Montgomery, TX (US); John Sauder, Conroe, TX (US)

Correspondence Address: Alan R. Thiele;Strasburger & Price, LLP, Suite 4300, 901 Main St., Dallas, TX, 75202, US

(21) Appl. No.: 11/068,579

(22) Filed: Feb. 28, 2005

(51) Int. Cl. F16C 1/10; G05G 9/00; B60K 20/00

(52) U.S. Cl. 74/500.5; 74/502.4

(57) ABSTRACT

An electromechanical cable actuator assembly suitable for use in a passenger vehicle includes a motor and a pulley, force is imparted to the cable by the pulley. Between the motor and the pulley are a face gear and spur gear set, an intermediate spur gear set, and a spur gear which causes rotation of the pulley.

This patent application claims priority from Provisional U.S. Patent Application No. 60/548,324, filed Feb. 27, 2004.

### FIELD OF INVENTION

The present invention pertains to a system for imparting a force on a cable; more particularly the present invention pertains to a system for imparting a force on a cable using a motor, a gear train, and a pulley. The pulley receives rotating force from the motor through the gear train and, when the pulley rotates, force is placed on the cable. The force causes the cable to move a predetermined distance.

### BACKGROUND

Changing consumer demands for passenger vehicles in the United States have encouraged automobile manufacturers to build multiple-use or utility vehicles that are suitable to carry both passengers and/or cargo. One of the keys to the adaptability of such utility vehicles to carry either passengers and/or cargo is the invention of complex seating systems which enable individual seats to fold, to flip, to collapse—which movements enable movement into and eventual storage of the seats in recesses built into the vehicle.

Complex seating systems require complex mechanical motion control mechanisms. These complex mechanical motion control mechanisms employ latches, levers and cables to govern seat movement and placement. As demand for newer and more complex seating arrangements increases, the need has arisen to provide electromechanical actuators when latches or other mechanical locking mechanisms are to be released from a remote location, or when additional force is needed, or extended cable travel is required.

Electromechanical actuators used in vehicle seating systems are subject to a variety of design constraints. Specifically, such vehicle-mounted electromechanical actuators must be small enough to be mounted unobtrusively within a vehicle, they must place a minimal energy demand on the electrical power system of a passenger vehicle, they must be capable of rapidly handling high loads, and they must operate quietly.

While a variety of systems have been used to transform the energy of a motor into linear force on a cable; there remains a need in the art for a vehicle-mounted system that combines speed with high load capacity to quietly impart a force on a cable to effect a predetermined movement of the cable in fractions of a second while minimizing the power demand on a vehicle's electrical system.

### SUMMARY

The disclosed vehicle-mounted electromechanical cable actuator assembly combines speed and quiet operation with a high load capacity to impart force on a cable to effect a predetermined movement of the cable in fractions of a second while minimizing the demands on a vehicle's electrical system.

The electromechanical cable actuator assembly of the present invention for exerting a force on a cable includes a motor whose electrical energy requirements are compatible with ability of a typical 12-volt electrical power system of a passenger vehicle to provide the needed electrical energy. Connected to the output shaft of the motor are a series of speed reduction and torque increasing gear sets which eventually cause a pulley to rotate. The rotation of the pulley imparts a force on a cable which is wound around the pulley.

The series of gear sets includes a face gear and spur gear set which engages a gear mounted to the output shaft of the motor. Engaging the face gear and spur gear set is an intermediate set of two spur gears. The intermediate set of two spur gears engages an arcuate or partial spur gear attached to a pulley.

The electromechanical cable actuator of the present invention also includes a spring driven backdrive collocated with the pulley. After the pulley has completed its rotation, the backdrive returns the pulley to its starting position.

### BRIEF DESCRIPTION OF DRAWING FIGURES

A better understanding of the electromechanical cable actuator assembly of the present invention may be had by reference to the drawing figures wherein:

FIG. 1 is a perspective view of an assembled electromechanical cable actuator assembly according to the present invention;

FIG. 2 is an exploded perspective view of the electromechanical cable actuator assembly shown in FIG. 1;

FIG. 3 is a side elevational view of the electromechanical cable actuator with the housing portions removed to illustrate the operation of the gear train;

FIG. 4 is a perspective view of the electromechanical cable actuator with portions removed to illustrate the operation of the spring driven backdrive functions;

FIG. 5A is a flowchart of the logic embodied in the electronic control of the disclosed invention for 1 cycle per switch activation; and

FIG. 5B is a flowchart similar to that shown in FIG. 5A for 2 cycles per switch activation.

### DESCRIPTION OF THE EMBODIMENTS

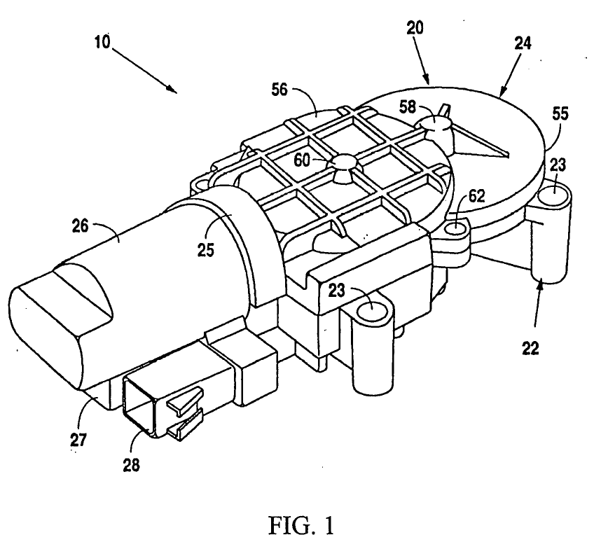

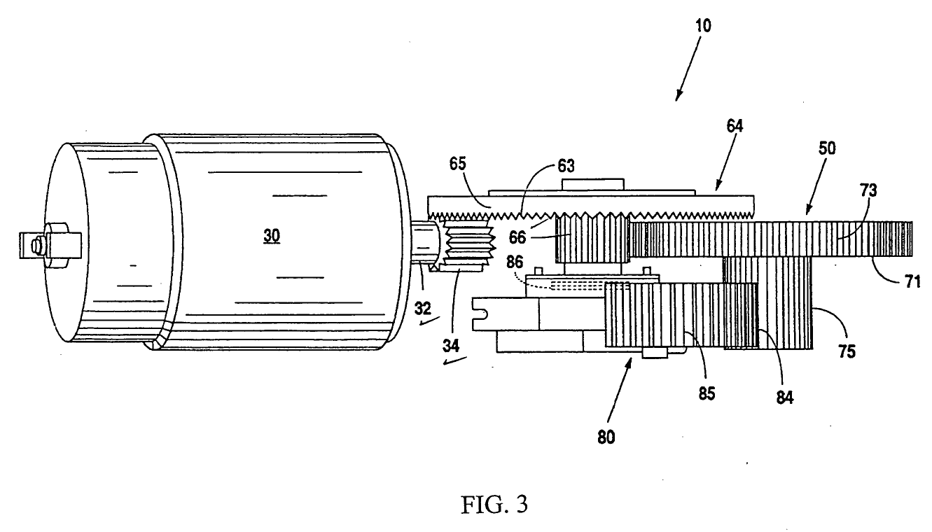

As will be seen in FIGS. 1, 2, 3, and 4, the electromechanical cable actuator 10 of the present invention is a self-contained device whose size is conducive to allowing its installation in a vehicle. To meet the requirements of automobile manufacturers, the disclosed electromechanical cable actuator 10 must be operable using the available electrical power provided by the electrical system typically found on a passenger vehicle. Specifically, the disclosed electromechanical actuator 10 must operate at a low voltage (specifically, 12 volts in most U.S. passenger vehicles) and have a small current draw (typically, 5 amps maximum). Yet, at the same time, the electromechanical actuator 10 must be able to impart a sufficient level of force on a cable to rapidly operate the mechanical locking portions of various different types of complex vehicle seating systems. Thus, when electrical power is supplied to the motor 30 through either the closing of a switch or by a remote device, the rotational force of the motor 30 will be quickly translated into a sufficient amount of linear force on a cable so that seating system (not shown) which is attached to the cable 44 will be unlocked from its locking system and thereby be allowed to properly fold, flip, or collapse. In addition to being small in size, the electromechanical cable actuator 10 must be easy to manufacture, low in cost, quiet in operation, simple to install, and readily connectable to the electrical system of a passenger vehicle.

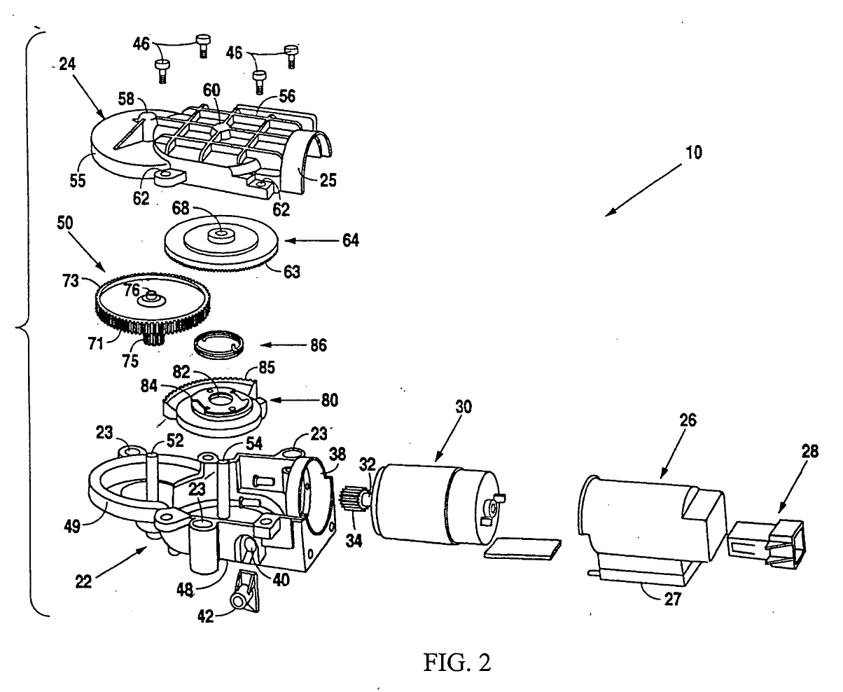

As will be seen in FIGS. 1 and 2, the disclosed electromechanical cable actuator 10 includes a housing assembly 20, which includes a lower housing assembly 22, an upper housing assembly 24, a housing 26 for the motor, and a power connection 28.

In the expanded view, FIG. 2, with the motor housing 26 moved away and the lower housing assembly 22 separated from the upper housing assembly 24, the construction of the electromechanical cable actuator 10 may be better understood by those of ordinary skill in the art.

As previously indicated, the motor 30 is used to drive the electromechanical cable actuator 10 of the present invention. The motor 30 is enclosed by a motor housing 26, which includes a portion 27 for the insertion of a circuit board to control the operation of the motor 30 and limit current draw. The output of the motor 30 is rotating output shaft 32. A small gear 34 is fitted to the output shaft 32. The small gear 34 turns with the output shaft 32.

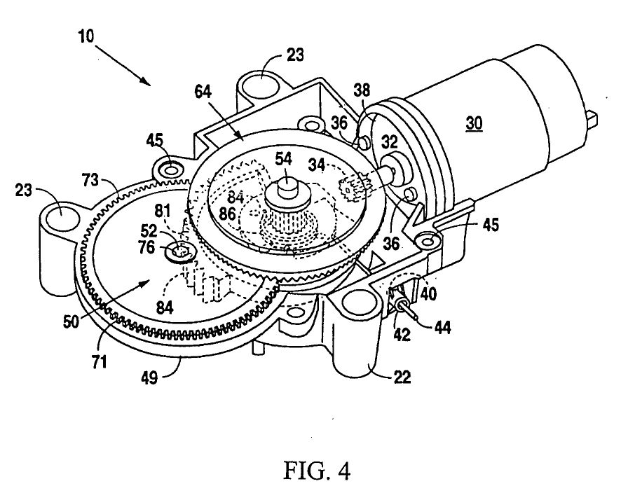

The motor assembly 30 is held in place by mounting screws 36 which pass through a motor mounting face 38 formed as part of the lower housing assembly 22. The lower housing assembly 22 includes multiple holes 23 on its perimeter through which mounting bolts may pass to affix the electromechanical cable actuator 10 of the present invention to a mounting point on a vehicle (not shown). Also, as may be seen in FIG. 4, located on the lower housing assembly 22 are a cable hole 40 and a cable guide 42. Cable hole 40 and cable guide 42 permit the cable 44 portion of the present invention to exit the electromechanical cable actuator 10. Also included on the lower housing 22 assembly are a plurality of small holes 45 through which fasteners 46 may be placed for attaching the lower housing assembly 22 to the upper housing assembly 24.

The portion of the lower housing assembly 22 closest to the motor 30 includes first a well 48 in which the rotatable pulley assembly 80 is mounted. The opposite end of the lower housing assembly 22 includes a second well 49 for the mounting of the intermediate spur gear assembly 50.

Extending upwardly from the bottom of the lower housing assembly 22 is a first shaft 52 on which the intermediate spur gear assembly portion 50 of the present invention is mounted. Also extending upwardly from the bottom of the lower housing assembly is a second shaft 54 on which the rotatable pulley assembly 80 and face gear and spur gear assembly 64 are mounted.

The upper housing assembly 24 includes an arcuate portion 25 which fits over the motor mounting face 38 on the lower housing assembly 22. At the distal end of the upper housing assembly is a flanged portion 55 which fits over the lower housing assembly 22. The flanged portion 55 encloses the intermediate spur gear assembly 50. Between the arcuate portion 25 and the flanged portion 55 is an intermediate portion 56. The intermediate portion 56 includes a first seat 58 for mounting the top of the first shaft 52 and a second seat 60 for mounting the top of the second shaft 54. Also included in the upper housing assembly 24 are a plurality of holes 62 through which fasteners 46 may pass to attach the upper housing assembly 24 to the lower housing assembly 22.

Positioned just under the upper housing assembly 24 is a face gear and spur gear assembly 64. The face gear and spur gear assembly 64 is turned by engagement of its teeth 63 with the small gear 34 affixed to the output shaft 32 of the motor 30. Because the face gear 65 and the spur gear 66 in the face gear and spur gear assembly 64 are made as one piece, when the face gear 65 turns, the spur gear 66 will also turn. The face gear and spur gear assembly 64 are mounted by engagement of the central hole 68 formed therein and the top portion of the second shaft 54.

Just beneath the face gear and spur gear assembly 64 is the intermediate spur gear assembly 50. The intermediate spur gear assembly 50 includes an upper large gear 71 whose teeth 73 engage the spur gear 66 of the face gear and spur gear assembly 64. Affixed to the underside of the intermediate spur gear assembly 50 is a small spur gear 75. Because the upper large spur gear 71 and the small lower spur gear 75 are formed as a single piece, when the large spur gear 71 turns, the lower spur gear 75 will also turn. Formed in the middle of the intermediate spur gear assembly is a hole 76 which enables the intermediate spur gear assembly 50 to be mounted on the first shaft 52.

Located under the intermediate spur gear assembly 50 is the rotatable pulley assembly 80. The rotatable pulley assembly 80 includes a central hole 82 so that it may be mounted on the first shaft 52. At the edge of the rotatable pulley assembly 80 is a spur gear section 84 which may be turned by engagement of its teeth 85 on the small spur gear 75 of the intermediate spur gear assembly 50.

Further included in the rotatable pulley assembly 80 is a spring return 86. The spring return 86 is depicted in FIG. 4. When the rotatable pulley assembly 80 is turned, energy is stored in a coil spring 86. The stored energy, when released from the coil spring 86, will restore the cable 44 to its original position.

In an alternate embodiment, the circuit board contained in the lower housing assembly 22 will include electronics which both limit the current draw and actuate the motor 30 for brief intervals when the energy in the spring 86 is released. The operation of the motor 30 for brief intervals both slows down and quiets the movement of the cable 44 to its start position.

Operation

The electromechanical cable actuator 10 of the present invention operates by first applying power to the motor assembly 30. The output shaft 32 of the motor assembly 30 is then caused to turn. Because a gear 34 is attached to the output shaft 32 of the motor assembly 30, the turning gear 34 which engages the teeth 63 of the face gear portion 65 of the face gear and spur gear assembly 64 will cause the face gear and spur gear assembly 64 to rotate. The engagement of the teeth 63 of the spur gear portion 66 of the face gear and spur gear assembly 64 with the teeth 73 of the large spur gear portion 71 of the intermediate spur gear assembly 50 will cause the small spur gear 75 to turn. This turning of the small spur gear 75 will cause the rotatable pulley assembly 80 to turn. Because the cable is affixed to the rotatable pulley assembly 80, the force on the cable 44 will cause it to move. This movement is of sufficient length and force to unlock a locking mechanism or provide the initiation of movement which will enable the seats in a vehicle to be properly positioned, as desired by the driver of the vehicle.

In the preferred embodiment of the invention, the cable travel was set to be approximately 34 mm. However, by modifying the various ratios and the size of the parts, it has been found that a cable travel of about 30 mm to about 55 mm falls within the capability of the disclosed invention.

In the preferred embodiment of the present invention, it has been found that a sufficient cable load to release commonly used latches is obtainable. By slight adjustments to the size of the various components, it will be understood by those of ordinary skill in the art that a force on the cable may range from about 350 newtons to about 600 newtons.

To assure that the electrical system of a passenger vehicle is not overloaded by the electromechanical cable actuator 10 of the present invention, it has been found that a motor 30 that provides a torque 140 N-mm to about 200 N-mm, whose current draw is about 5 amps in a 12-volt system, is preferable. To achieve the desired speed of cable operation, it has been found that a motor whose operating speed is from about 1,500 rpm to about 3,500 rpm is satisfactory. The time for the cable to travel through the predetermined travel length ranges from about 0.5 secs. to about 1.5 secs.

In the preferred embodiment, the drive train provides a gear ratio of about 109:1. It will be understood by those of ordinary skill in the art that the disclosed system will enable a speed reduction in the range of about 100:1 to 125:1.

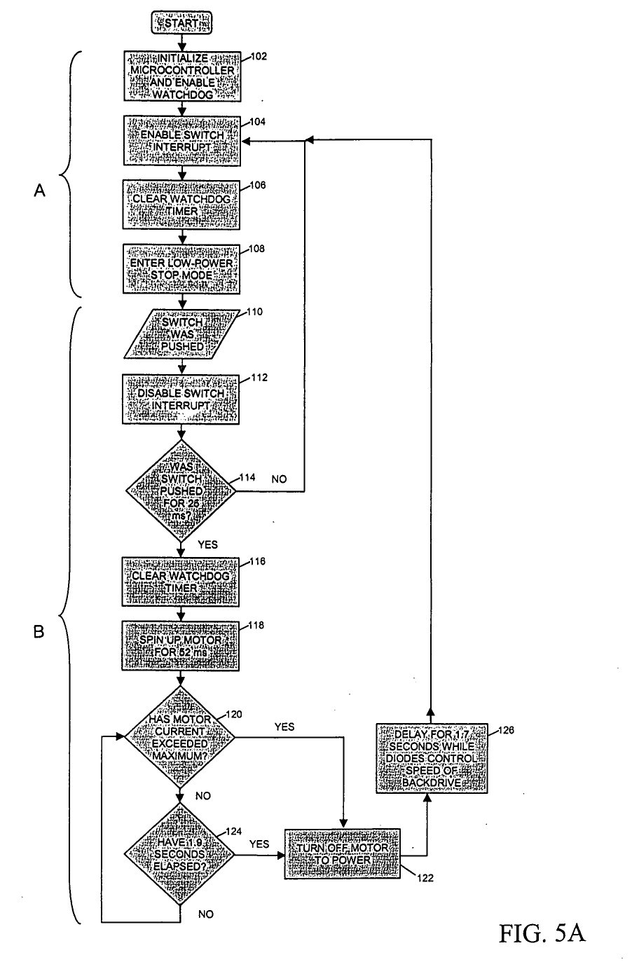

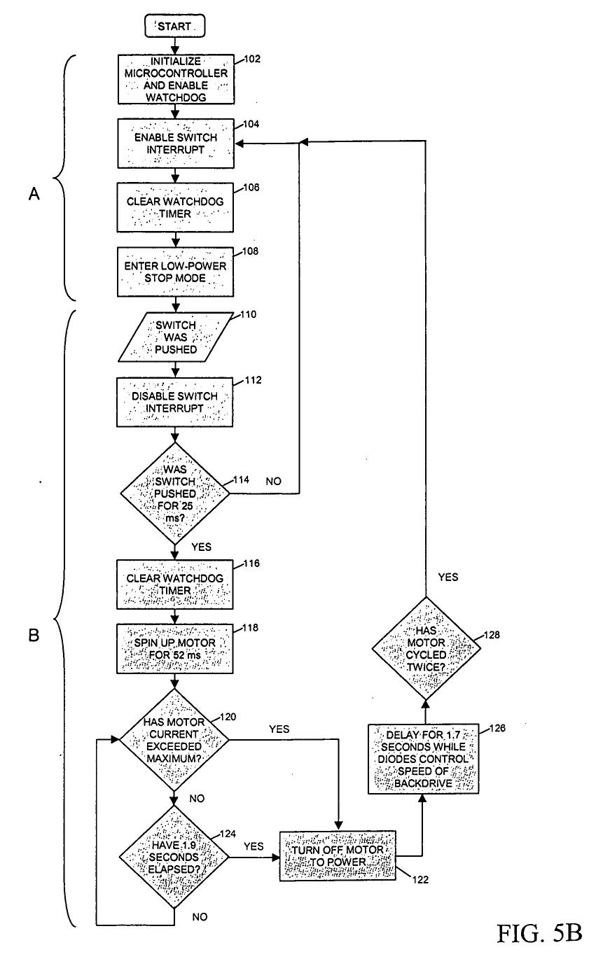

The operation of the system is controlled pursuant to the flowcharts at FIG. 5A and FIG. 5B. FIG. 5A demonstrates the operation of a single cycle of the system per activation of an activation switch. FIG. 5B is similar to FIG. 5A but shows two cycles of the system per activation of an activation switch.

As may be seen in FIG. 5A and FIG. 5B, both flowcharts include an initial group of steps A which set up the imbedded logic in the system before the activation of the activation switch is sensed. The steps in Group A begin with an initialization and watchdog enablement step 102. Once completed, the switch interrupt function is enabled 104 and the watchdog time is cleared 106. To conserve energy, system is then directed into a low-power mode 108.

The activation 110 of the activation switch begins those steps designated as Group B. This triggers disabling the switch interrupt function 112. If the activation switch was only activated for a short period of time, as could happen if the switch were inadvertently bumped, the logic step 114 returns the system to step 104. If the designated period of time is exceeded, in the preferred embodiment 25 ms, the watchdog timer is cleared 116 and the motor 30 is activated 118 for a designated period of time. A current limit step 118 assures that the maximum designated current draw has not been exceeded. If an excess current draw is sensed, the motor 30 is turned off in step 122. If the current draw is not exceeded, the time of operation of the motor 30 is measured and compared with a preset time in step 124. If the motor is turned off, there is a built-in delay 126 where the speed of the backdrive is controlled.

In the backdrive situation, energy stored in the return spring 86 causes the motor 30 to turn. The rotational force of the spring 86 therefore causes the motor 30 to act like a generator and produce electrical energy. Bi-directional diodes are used to limit the voltage that motor 30 can produce when acting as a generator. The interruption of motor operation and the use of the bi-directional diodes facilitate return of the cable 44 to its starting position at a near-constant rate and a significant reduction in the operating noise of the electromechanical actuator 10.

In FIG. 5B, those of ordinary skill in the art will notice that an additional step 128 has been added which determines whether or not the motor 30 has cycled twice. If the motor 30 has cycled only once, then the motor 30 is caused to cycle again. If the motor 30 has cycled twice, then the logic flow goes to the top of the flowchart.

There is thereby provided by the present invention an electromechanical cable actuator which is suitable for use in a passenger vehicle. The disclosed electromechanical cable actuator will provide the necessary forces and operate with the necessary speed and reliability to perform a large variety of functions in vehicles in addition to simply operating complex seating system mechanisms.

While the disclosed invention has been described in terms of its preferred and alternate embodiments, those of ordinary skill in the art will understand that numerous other embodiments of the present invention may become apparent while reading of the foregoing disclosure. Such other embodiments shall be included within the scope and meaning of the appended claims.

What is claimed is:

1. An electromechanical cable actuator assembly comprising:
a motor having an output shaft with a gear mounted thereon;
a first gear assembly for receiving rotational power from said gear mounted on said output shaft of said motor;
a second gear assembly in engagement with said first gear means for receiving rotational power from said first gear means;
a cable and pulley assembly in engagement with said second gear means;
whereby the turning of said motor will result in torque on said pulley and a linear force on the cable.

2. The electromechanical cable actuator assembly as defined in claim 1 further including a housing enclosing said first gear assembly, said second gear assembly and said cable and pulley assembly.

3. The electromechanical cable actuator assembly as defined in claim 2 wherein said cable and pulley assembly further includes a spring loaded cable return assembly.

4. The electromechanical cable actuator assembly as defined in claim 2 wherein said first gear assembly includes a face gear which engages said gear mounted on said output shaft of said motor and a first spur gear rigidly affixed to said face gear, said face gear and said first spur gear having co-axial central openings formed therein.

5. The electromechanical cable actuator assembly as defined in claim 2 wherein said second gear assembly includes a second spur gear which engages said first spur gear of said first gear assembly and a third spur gear rigidly affixed to said second spur gear, said second spur gear and said third spur gear having co-axial central openings formed therein.

6. The electromechanical cable actuator assembly as defined in claim 2 wherein said cable and pulley assembly includes a fourth spur gear which engages said third spur gear of said second gear assembly.

7. The electromechanical cable actuator assembly as defined in claim 4 further including a first shaft within said housing, said first shaft constructed and arranged to engage said cable and pulley assembly and to pass through said central opening in said first gear assembly.

8. The electromechanical cable actuator assembly as defined in claim 5 further including a second shaft with said housing, said second shaft constructed and arranged to pass through said central opening in said second gear assembly.

9. A vehicle-mounted system for placing a linear force on a cable using a low voltage, low amperage rotating motor, said system comprising:
a rotatable pulley constructed and arranged to store the cable and to place linear force on the cable when rotated;
a spur gear connected to said rotatable pulley for providing rotating force to said rotatable pulley;
an intermediate spur gear set constructed and arranged to engage and rotate said spur gear;
a face gear and spur gear set constructed and arranged to engage and rotate said intermediate spur gear set;
a motor including an output shaft with a gear mounted thereon constructed and arranged to engage said face gear and to rotate said face gear and spur gear set;
whereby rotation of said motor places a linear force on the cable.

10. The vehicle-mounted system as defined in claim 9 wherein said spur gears in said spur gear set are co-axially attached to one another about a central opening.

11. The vehicle-mounted system as defined in claim 9 wherein said face gear and said spur gear in said face gear and spur gear set are co-axially attached to one another about a central opening.

12. The vehicle-mounted system as defined in claim 9 further including a spring driven back drive attached to said rotatable pulley.

13. A method for imparting linear motion to the cable portion of a cable operated system in a vehicle, said method comprising the steps of:
mounting the cable to a rotatable pulley;
mounting said rotatable pulley to a spur gear;
causing said spur gear to engage a spur gear set;
causing said spur gear set to engage the spur gear portion of a face gear and spur gear set;
rotating said face gear with a motor;
whereby the rotation of said motor will turn said face gear, which in turn rotates said spur gear portion of said face gear and spur gear set, which in turn rotates said spur gear set, which in turn rotates said rotatable pulley and places linear force on the cable.

14. The method as defined in claim 13 wherein said rotatable pulley is connected to a spring loaded cable return assembly.

15. The method as defined in claim 13 wherein said series of gear engagements provides a speed reduction from the rotational speed of the motor to the rotational speed of the rotatable pulley in the range of about 100:1 to about 125:1.

16. The method as defined in claim 13 wherein said motor is selected to have a torque of about 140 N-mm to about 200 N-mm, with a current draw of about 5 amps at 12 volts.

17. The method as defined in claim 13 wherein said motor is selected to operate in a range of about 1,500 rpm to about 3,500 rpm.

18. The method as defined in claim 13 wherein the sizes of said gears and said rotatable pulley are selected to enable a cable travel in the range of about 30 mm to about 55 mm.

19. The method as defined in claim 17 wherein the time for said cable travel is in the range of about 0.5 secs. to about 1.5 secs.

20. The method as defined in claim 13 wherein the sizes of said gears and said rotatable pulley are selected to enable a force on the cable in the range of about 350 Newtons to about 600 Newtons.
